(19) United States
(12) Patent Application Publication
(10) Pub. No.: US 2010/0191809 A1
(43) Pub. Date: Jul. 29, 2010

(54) Capability to capture and share image displayed from multicast video

(75) Inventors: Gerardo M. Espinosa, Plano, TX (US); Kashi G. Rao, Plano, TX (US)

Correspondence Address: ALCATEL-LUCENT, C/O GALASSO & ASSOCIATES, LP, P. O. BOX 26503, AUSTIN, TX, 78755-0503, US

(73) Assignee: ALCATEL-LUCENT USA INC.

(21) Appl. No.: 12/321,674

(22) Filed: Jan. 23, 2009

(51) Int. Cl. G06F 15/16; H04N 7/173

(52) U.S. Cl. 709/206; 725/110

(57) ABSTRACT

The present invention provides a method and device for an IPTV subscriber viewer to capture and store a snapshot of the image displayed on a, television screen. An IPTV subscriber has the capability to capture, using a special button on the remote control, the current video image content displaying, for example, contact information in an advertisement. This information can be stored on the subscriber's set-top box and can be sent as an e-mail attachment to the subscriber's e-mail account. The subscriber can then save this information in his own e-mail account and access it via any device having e-mail capabilities.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to the IPTV industry. The invention discussed herein is in the general classification of IPTV screen capture image technology.

### BACKGROUND

Internet Protocol Television (IPTV) allows digital television service to be delivered via the Internet. IPTV is capable of receiving and displaying a video stream encoded as a series of IP packets. IPTV is a complicated system with a large database and many live subscribers. Periodically, software upgrades may require a change in the baseline data schemas in the form of database patches. The IPTV system also must be checked periodically to validate its integrity through end-to-end health checks.

As with any conventional television broadcast, commercials are regularly shown during regular IPTV programming. Commercials often contain written information for advertising purposes such as a contact phone number, e-mail address of web address that a user/subscriber may wish to record and utilize at a later time. Unfortunately, a subscriber often does not have a writing utensil and paper conveniently located nearby while watching television, allowing the information to disappear from the television screen by the time he locates this equipment.

Commercial multicast television content usually includes a company's contact information such as telephone numbers, facsimile numbers and/or Internet site Uniform Resource Locators (URLs) for the company or intermediate companies which in turn display a large variety of information on products and/or services. Sometimes these companies also acquire a paid-programming space targeted to advertise these products during regular commercials breaks or even as part of regular television shows. The ability to capture some of this information for later use would be an enormous benefit to many IPTV subscribers.

In addition, it is advantageous for an IPTV subscriber to be able to capture the image on a television screen for purposes of identifying quality problems in the video stream to an IPTV customer care agent.

At present, there is no viable solution for taking a snapshot of a video image on a television screen to preserve it for viewing in the future for any purpose, including diagnosing quality control issues or for obtaining advertising information contained therein.

Although IPTV does provide for recording and rewinding technology, these functions may not allow a user to capture information displayed on the screen before that information is permanently lost. The rewinding and recording features of IPTV would permit storage of information displayed on a screen at least temporarily, however, these features have their limitations and would not be useful for diagnosing video quality problems.

The rewinding feature of IPTV is limited in duration, often to an hour or two of programming. A user would be able to rewind through programming to locate an advertisement for this limited period of time. However, he would eventually lose this ability and would still need to manually record the contact information displayed on the screen at some point.

The recording feature is also an option, however, a subscriber usually must know that an advertisement is coming in advance to utilize this feature. He would also still need to search through extended programming to find an advertisement and risk losing the desired image if the programming is accidentally erased.

There is no known capability to capture advertising information on a television screen through an easy and practical mechanism, store this information within the subscriber's private contact list within the IPTV user's menu or send this information to another device for later storage and use. Manual user intervention is required by the subscriber to store advertising information usually via note taking before the information disappears from the screen.

Hence, there is a need in the art for a convenient to use, reliable, inexpensive and efficient method and device that allows an IPTV subscriber to capture and store a snapshot of an image displayed on a television screen.

### SUMMARY OF THE DISCLOSURE

The present invention provides a method and device that allows an IPTV subscriber to capture and store a snapshot of an image displayed on a television screen.

In the preferred embodiment of this invention, an IPTV subscriber has the capability to capture, using a special button on the remote control, the current video image content displaying, for example, a businesses' advertisement contact information on multicast television deployments. This screen image can be stored on the subscriber's set-top box and/or can be sent as an e-mail attachment as a jpeg file to the subscriber's e-mail account. The subscriber can then save this information in his own e-mail account contact list and access it via any device having e-mail capabilities. The jpeg file screen capture can also be forwarded to a customer care representative for analysis of video quality control issues.

The principal object of this invention is to provide a method and device for an IPTV subscriber to capture a snapshot of the image displayed on a television screen at any point in time.

Another object of this invention is to provide a method and device for an IPTV subscriber to store a snapshot of the image displayed on a television screen at a set-top box.

Another object of this invention is to provide a method and device for an IPTV subscriber to forward a snapshot of the image displayed on a television screen to an e-mail address.

Another object of this invention is to provide a method and device to permit an IPTV subscriber to capture an image on a television screen for purposes of obtaining contact information or other information from an advertisement.

Another object of this invention is to provide a method and device to permit an IPTV subscriber to capture an image on a television screen to report video stream quality issues to an IPTV customer care agent.

Another object of this invention is to provide a method and device that efficiently permits an IPTV subscriber to capture an image on a television screen to obtain contact information or other information from an advertisement.

Another object of this invention is to provide a method that is relatively inexpensive to implement to permit an IPTV subscriber to capture an image on a television screen to obtain contact information or other information from an advertisement.

Another object of this invention is to provide a reliable method to permit an IPTV subscriber to capture an image on a television screen to obtain contact information or other information.

### BRIEF DESCRIPTION OF THE DRAWINGS

FIG. 1 depicts a diagram showing the subscriber to subscriber capture and transport of a screen image in the preferred embodiment.

FIG. 2 depicts a diagram showing the subscriber to customer care agent capture and transport of a screen image in the preferred embodiment.

### DETAILED DESCRIPTION OF THE DRAWINGS

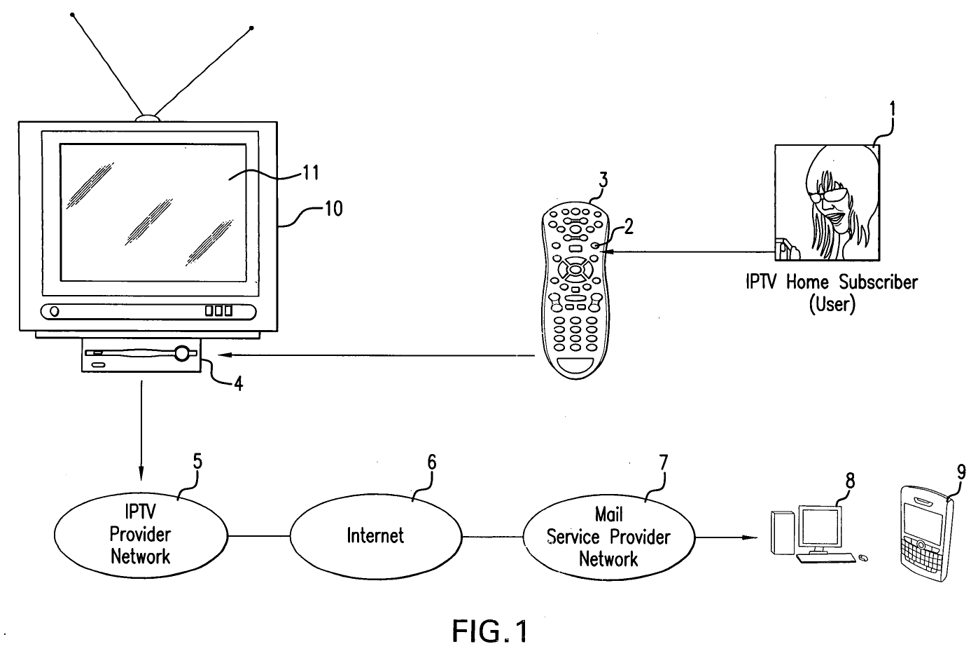

FIG. 1 depicts a diagram showing the subscriber to subscriber capture and transport of a screen image in: the preferred embodiment. An IPTV home subscriber 1 presses a screen capture button 2 on a remote control 3 to send a request from the remote control 3 to a set-top box 4 connected to a television 10 to capture the image currently displayed on the television screen 11.

The remote control 3 is a standard remote control, but, in this preferred embodiment, it will include an additional button (screen capture button 2) to provide the necessary functionality. The set-top box 4 also will have the proper functionality to process the screen capture request coming from the remote control 3.

The set-top box 4 connects to the IPTV Provider Network 5 and instructs the IPTV server to send the screen capture image as a jpeg file attachment of an e-mail to a user's SMTP (Simple Mail Transport Protocol) account. A message can also be appended to the e-mail at the IPTV Provider Network 5, if desired. The screen capture image can then be sent over the Internet 6 to the Mail Service Provider Network 7 connected to a user's home PC 8, mobile device 9 or other devices having e-mail capabilities. The IPTV home subscriber 1 or other user/subscriber can then use these devices to check his e-mail inbox for an e-mail containing the screen capture image as an attachment.

In instances where multiple e-mail address are available in an IPTV subscriber's account, the IPTV subscriber may opt for all addresses or some subset of those addresses to receive an e-mail with the screen image attachment.

The user may set up profile information as a priority or default such as the mailbox to which the captured information will automatically be sent. This information may be stored in some sort of user storage repository in the IPTV Provider Network 5.

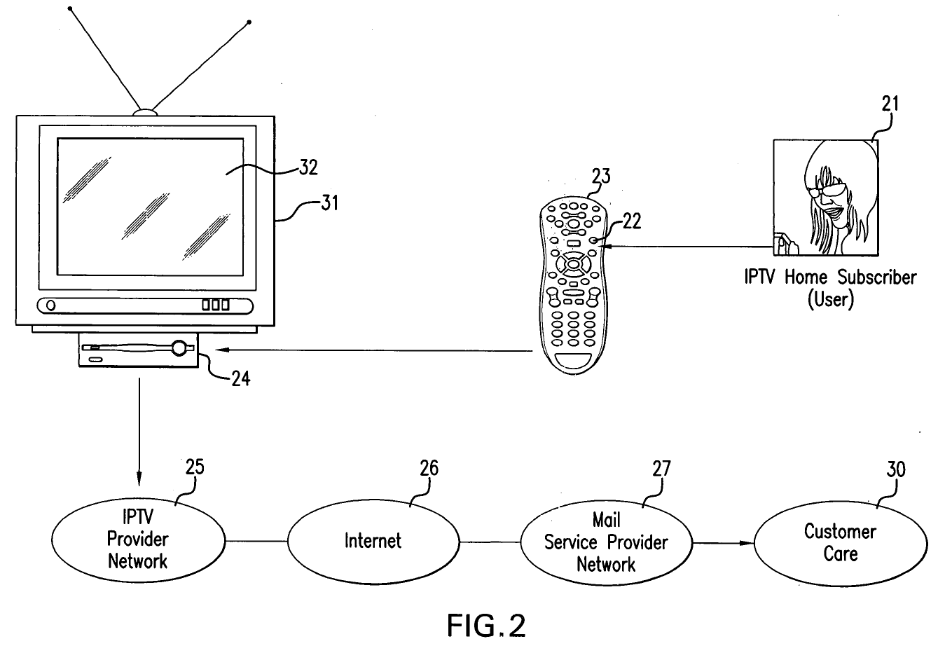

FIG. 2 depicts a diagram showing the subscriber to customer care agent capture and transport of a screen image in the preferred embodiment. This type of screen capture is advantageous for allowing a subscriber to send a screen image to a customer care agent when video steam quality or other issues arise at the subscriber's set-top box.

This subscriber to customer care agent capture of a screen image operates in much the same manner as the subscriber to subscriber screen capture and transport of an image. An IPTV home subscriber 21 presses a screen capture button 22 on a remote control 23 to send a request from the remote control 23 to a set-top box 24 connected to a television 31 to capture the image currently displayed on the television screen 32.

The remote control 23 is again a standard remote control, but, in this preferred embodiment, includes an additional button (screen capture button 22) to provide the necessary functionality. The set-top box 24 also will have the proper functionality to process the screen capture request coming from the remote control 23.

The set-top box 24 connects to the IPTV Provider Network 25 and instructs the IPTV server to send the screen capture image as a jpeg file attachment of an e-mail to a user's SMTP (Simple Mail Transport Protocol) account. A message can also be appended to the e-mail at the IPTV Provider Network 25, if desired.

The screen capture image can then be sent over the Internet 26 to the Mail Service Provider Network 27 connected to a user's home PC or other devices having e-mail capabilities. The IPTV home subscriber 21 can then use these devices to check his e-mail inbox for an e-mail containing the screen capture image as an attachment.

The e-mail containing the screen capture image as an attachment can then be forwarded to Customer Care 30 for inspection and analysis to determine what problems exist in the video stream quality.

Although this invention is meant to capture contact information, it can be used. to capture any image being displayed on a television screen. In addition, it can be used as a troubleshooting aide for the IPTV provider to sniff the video stream quality experienced by the subscriber (i.e. as a side effect of a quality problem reported by a subscriber).

For digital right management purposes, it is optionally recommended to add a disclosure statement on e-mails containing the attached captured image indicating that it is forbidden to distribute the image to other e-mail accounts. The same type of statement can also be communicated to the user as part of the application registration/set-up.

It is contemplated that the method described herein can be implemented as software, including a computer-readable medium having program instructions executing on a computer, hardware, firmware, or a combination thereof. The method described herein also may be implemented in various combinations on hardware and/or software.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A method of capturing a screen image displayed on a television utilizing Internet Protocol Television (IPTV) comprising the steps of:
utilizing a screen capture button on a remote control to send a request from the remote control to a set-top box connected to the television to capture the screen image currently displayed on the television.

2. The method of claim 1 further comprising the step of:
storing the screen image on the set-top box for future retrieval.

3. The method of claim 1 further comprising the step of:
sending the screen image from the set-top box to an IPTV provider network.

4. The method of claim 3 further comprising the step of:
creating an e-mail at the IPTV provider network with the screen image as an e-mail attachment.

5. The method of claim 4 further comprising the step of:
sending the e-mail to a designated e-mail address over the Internet and through a mail service provider network connected to a subscriber's device having e-mail capabilities.

6. The method of claim 5 further comprising the step of:
sending the e-mail to a customer care agent for inspection of the screen image to perform quality assistance.

7. The method of claim 4 further comprising the step of:
appending a message to the e-mail.

8. The method of claim 7 wherein the step of appending a message to the e-mail includes providing a statement regarding digital rights management.

9. The method of claim 4 wherein the e-mail attachment is a jpeg file.

10. A method of capturing a screen image displayed on a television comprising the steps of:
(a) utilizing a screen capture button on a remote control to send a request from the remote control to a set-top box connected to a television to capture a screen image currently displayed on the television;
(b) storing the screen image on the set-top box for future retrieval;
(c) sending the screen image from the set-top box to an IPTV provider network;
(d) creating an e-mail at the IPTV provider network with the screen image as an e-mail attachment; and
(e) sending the e-mail to a designated e-mail address over the Internet and through a mail service provider network connected to a subscriber's device having e-mail capabilities.

11. The method of claim 10 further comprising the step of:
sending the e-mail to a customer care agent for inspection of the screen image to perform quality assistance.

12. The method of claim 10 further comprising the step of:
appending a message related to digital rights management to the e-mail.

13. A system for use with IPTV services comprising:
a remote control having a plurality of buttons for interacting with a set-top box connected to a television wherein the plurality of buttons includes a screen capture button to allow a user to store a screen image displayed on the television at the set-top box.

14. The system of claim 13 wherein the set-top box is capable of sending instructions to an IPTV Provider Network to send an e-mail containing the screen image as an attachment
